(19) United States
(12) Patent Application Publication
(10) Pub. No.: US 2007/0147487 A1
(43) Pub. Date: Jun. 28, 2007

(54) Apparatus, method and computer program product providing dynamic modulation setting combined with power sequences

(75) Inventors: Frank Frederiksen, Klarup (DK); Preben Mogensen, Gistrup (DK); Troels Kolding, Klarup (DK); Olav Tirkkonen, Helsinki (FI); Klaus Hugl, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/644,740

(22) Filed: Dec. 22, 2006

Related U.S. Application Data
(60) Provisional application No. 60/754,440, filed on Dec. 27, 2005.

(51) Int. Cl. H04L 5/16

(52) U.S. Cl. 375/222

(57) ABSTRACT

Disclosed herein are apparatus, methods and computer program products for transmitting signals in different frequency sub-bands used in a particular cell of a cellular wireless communications system in accordance with a power sequence and for selecting modulation schemes to be used in transmitting the signals in the different frequency sub-bands in dependence on signal transmission power allocated to the sub-bands in the power sequence. In the power sequence, signals to be transmitted in at least one sub-band are allocated a higher signal transmission power level than signals to be transmitted in other sub-bands used in the particular cell of the cellular wireless communication system. The differing signal transmission power levels allocated to the different sub-bands typically results in different SINR for signals transmitted at the higher signal transmission power levels and signal transmitted at the lower signal transmission power levels. In order to reduce the SINR difference between signals transmitted in the different sub-bands, modulation schemes are selected in dependence on the signal transmission power levels allocated to signals transmitted in the sub-bands.

### CLAIM OF PRIORITY FROM A COPENDING PROVISIONAL PATENT APPLICATION

Priority is herewith claimed under 35 U.S.C. § 119(e) from co-pending Provisional Patent Application 60/754,440, filed on Dec. 27, 2005 by Frank Frederiksen, Preben Mogensen, Troels Kolding, Olav Tirkkonen and Klaus Hugl entitled “APPARATUS, METHOD AND COMPUTER PROGRAM PRODUCT PROVIDING DYNAMIC MODULATION SETTING COMBINED WITH POWER SEQUENCES”. The disclosure of this Provisional Patent Application is hereby incorporated by reference in its entirety as if fully restated herein.

### TECHNICAL FIELD

The exemplary and non-limiting embodiments of this invention relate generally to wireless communications systems and, more specifically, relate to the transmission of an information stream to a receiver.

### BACKGROUND

The following abbreviations are herewith defined:
3GPP Third Generation Partnership Project
16-QAM 16 state quadrature amplitude modulation
64-QAM 64 state quadrature amplitude modulation
AMC adaptive modulation and coding
BS base station (also referred to as a Node B)
OFDM orthogonal frequency division multiplex
RF radio frequency
RRM radio resource management
UE user equipment
UTRAN universal terrestrial radio access network
QPSK quadrature phase shift keying
SINR signal to interference plus noise ratio

The so-called evolved UTRAN (E-UTRAN) is currently a study item within the 3GPP. For the E-UTRAN system OFDM has been selected as the multiple access scheme for the downlink (i.e., in the direction from the BS to the UE).

In order to obtain maximum flexibility and also increase the potential peak data rate, one approach is to allocate the full system bandwidth at all cells in the system (thus setting the frequency reuse factor to 1/1). However, this approach creates the potential for a problem to occur at cell edges, where the interference from other cells may be so strong that reception is not possible at all.

Reference may be had to 3GPP, “Physical Layer Aspects for Evolved UTRA”, TR 25.814, v 1.0.1 (2005-11). For example, section 7.1.2.6 is directed to downlink inter-cell interference mitigation.

The concept of using per sub-carrier modulation for optimum performance has been noted (especially when considering frequency domain link adaptation), but it is a complex task to also transmit the modulation scheme information for all sub-carriers. Reference in this regard may be had to “A Blockwise Loading Algorithm for the Adaptive Modulation Technique in OFDM Systems”, Grunheid, R.; Bolinth, E.; Rohling, H., Vehicular Technology Conference, 2001, VTC 2001 Fall EEE VTS 54th, Vol. 2, 7-11 Oct. 2001, pages 948-951, vol. 2.

Reference may also be had to “Bit and Subcarrier Allocation for OFDM Transmission Using Adaptive Modulation”, Chu, H; An, C.; Proceedings of the 7th Korea-Russia International Symposium, KORUS 2003, pages 82-85. These authors propose changing the channel modulation scheme according to estimated channel state information.

### SUMMARY OF THE INVENTION

A first embodiment of the invention is a method comprising: dividing system bandwidth in a wireless communication system into a plurality of sub-bands; using at least two sub-bands of the plurality for transmitting signals in a particular cell of the wireless communication system; allocating signal transmission power for use in transmitting signals in each of the sub-bands in use in the particular cell in accordance with a power sequence; selecting modulation schemes for transmitting signals in each of the sub-bands in use in the particular cell in dependence on signal transmission power allocated to each of the sub-bands in use in the particular cell; and transmitting signals in the sub-bands of the particular cell in accordance with the power sequence and selected modulation schemes.

A second embodiment of the invention is a user equipment comprising: a memory storing a program configured to control the user equipment when executed; a transceiver configured for bidirectional communication across a plurality of sub-bands in a cellular wireless communications system; a data processor coupled to the memory and transceiver, the data processor configured to execute the program and to control the user equipment; and wherein the transceiver is further configured to receive a plurality of signals transmitted in a plurality of sub-bands within a particular cell of the cellular wireless communications system, wherein each signal transmitted in a particular sub-band is both transmitted in accordance with a power sequence, wherein the power sequence assigns a signal transmission power level to at least one of the sub-bands that is different from the signal transmission power levels assigned to other sub-bands; and modulated using a modulation scheme selected in dependence on the signal transmission power level allocated to the sub-band.

A third embodiment of the invention is a base station comprising: a memory storing a program configured to control the base station when executed; a transceiver configured for bidirectional communication across a plurality of sub-bands in a cellular wireless communications system; a data processor coupled to the memory and transceiver, the data transceiver configured to execute the program and to control the base station; and wherein the transceiver is further configured to transmit a plurality of signals in a plurality of sub-bands of a particular cell in a cellular wireless communications system, wherein each signal transmitted in a particular sub-band is both transmitted in accordance with a power sequence, where the power sequence assigns a signal transmission power level to at least one of the sub-bands that is different from the signal transmission power levels that are assigned to other sub-bands; and modulated using a modulation scheme selected in dependence on the signal transmission power level assigned to the particular sub-band.

A fourth embodiment of the invention comprises a computer program product comprising a computer readable memory medium tangibly embodying a computer readable program, the computer readable program executable by data processing apparatus, the computer readable program, when executed by data processing apparatus, configured to divide system bandwidth in a wireless communication system into a plurality of sub-bands; to use at least two sub-bands of the plurality for transmitting signals in a particular cell of the wireless communication system; to allocate signal transmission power for use in transmitting signals in each of the sub-bands in use in the particular cell in accordance with a power sequence; to select modulation schemes for transmitting signals in each of the sub-bands in use in the particular cell in dependence on signal transmission power allocated to each of the sub-bands in use in the particular cell; and to transmit signals in the sub-bands of the particular cell in accordance with the power sequence and selected modulation schemes.

A fifth embodiment of the invention comprises a computer program product comprising a computer readable memory medium tangibly embodying a computer readable program, the computer readable program executable by data processing apparatus, the computer readable program, when executed, configured to receive a signal indicating signal transmission power levels used in transmitting at least first and second signals in at least first and second sub-bands in a particular cell of a cellular wireless communications system; to determine the modulation schemes used to modulate the first and second signals in dependence on the signal indicating the signal transmission power levels used to transmit the first and second signals; and to demodulate the signals in accordance with the determined modulation schemes.

### BRIEF DESCRIPTION OF THE DRAWINGS

In the attached Drawing Figures:

FIG. 1 shows a simplified block diagram of various electronic devices that are suitable for use in practicing the exemplary embodiments of this invention;

FIG. 2 is a conceptual block diagram of a portion of the Node B of FIG. 1, and illustrates the use of different modulation schemes applied by modulators in different sub-bands transmitted on the downlink to the UE of FIG. 1, as a function of the power level of the sub-bands;

FIG. 3 is a conceptual block diagram of a portion of the UE of FIG. 1, and illustrates the use of different demodulation schemes applied by demodulators (DEMOD) in demodulating signals from different sub-bands received on the downlink from the Node B of FIG. 1, as a function of the power level of the sub-bands;

FIG. 4 is a plot of uncoded error performance of different modulation schemes, where it can be seen that there exists a 4-5 dB Eb/No difference between the QPSK, 16-QAM and 64-QAM modulation schemes; and

FIG. 5 is a flowchart depicting a method operating in accordance with the invention.

### DETAILED DESCRIPTION

One possible approach to circumvent the interference problem discussed above is to use a method that can be referred to as power sequencing in the time or frequency domain. From a network planning/coordination point of view, the power sequence method in the frequency domain is the most attractive. The power sequences would be typically employed such that the total system bandwidth is divided into three equal-sized sub-bands which have different transmit power levels allocated for different cells/sectors. Simulations have shown that good performance is obtained where one sub-band is transmitted at a certain power level, while the other two sub-bands are transmitted at power levels that are different from the power level of the strongest sub-band. As a non-limiting example, the other two sub-bands may be transmitted at power levels that are approximately 4 dB lower than the power level of the strongest sub-band.

However, consider a case where the power sequencing method is applied, and also where a user is to be scheduled over the full system bandwidth, or where a user may be scheduled resources simultaneously in a high power and a low power part of the spectrum, while perhaps not over the full system bandwidth. It can be shown that this scenario will cause some bits/symbols to be transmitted (and thus also received) with a higher power than others, thereby resulting in a higher received SINR value for these transmitted bits/symbols.

It has been realized that the sub-band to sub-band power difference of 4 dB is approximately equal to the SINR difference between different modulation schemes. That is, the difference in SINR to achieve a certain bit error rate (BER) between QPSK and 16-QAM is approximately 4-5 dB, and the SINR difference between 16-QAM and 64-QAM is also approximately 4-5 dB. This SINR difference between modulation schemes is thus exploited for data rate optimization by selecting an appropriate modulation scheme for the different sub-bands.

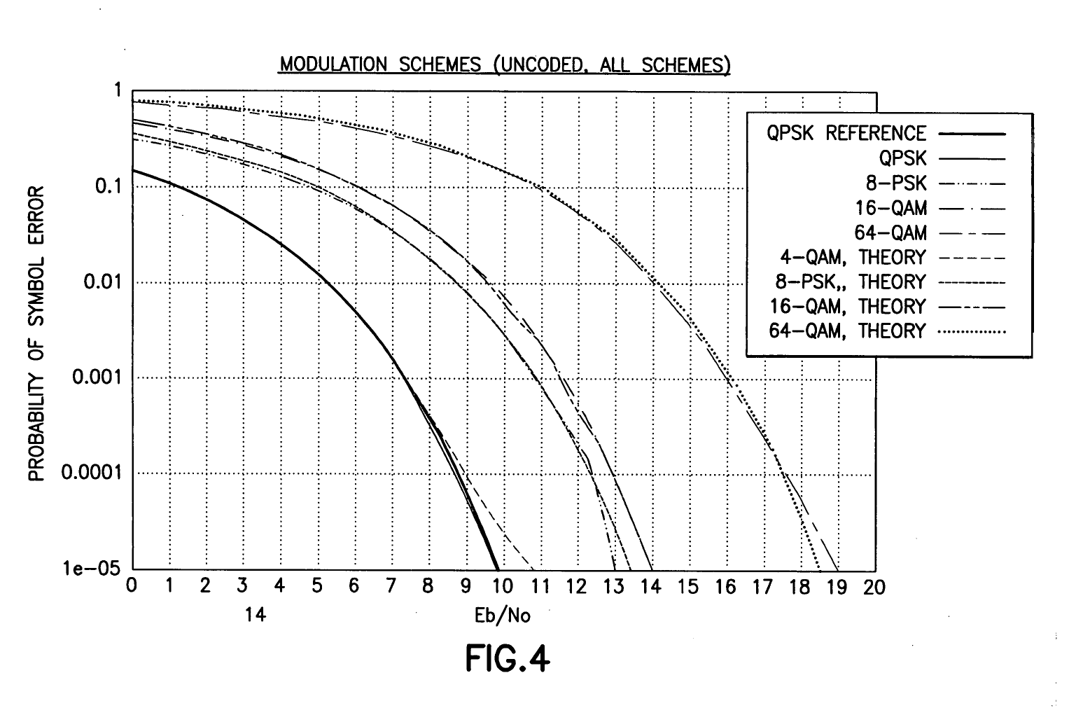

FIG. 4 is a plot of uncoded error performance of different modulation schemes, where it can be seen that there exists a 4-5 dB Eb/No difference between the QPSK, 16-QAM and 64-QAM modulation schemes.

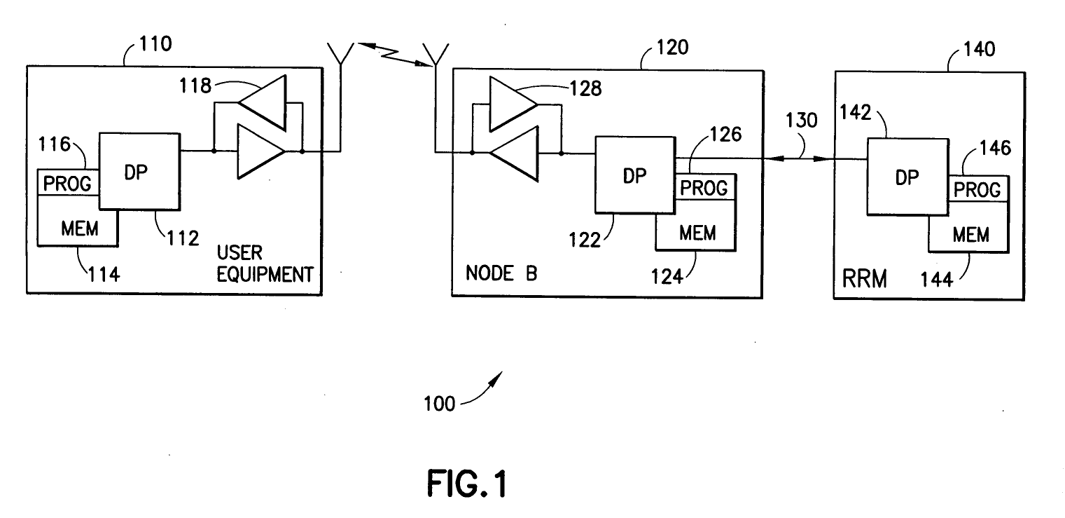

Reference is made first to FIG. 1 for illustrating a simplified block diagram of various electronic devices that are suitable for use in practicing the exemplary embodiments of this invention. In FIG. 1 a wireless network 100 is adapted for communication with a UE 110 via a Node B (base station) 120. The network 100 may include a RRM 140, which may be referred to as a serving RRM (SRRM), or another entity that handles control setup and other functions. The UE 110 includes a data processor 112, a memory 114 that stores a program 116, and a suitable radio frequency transceiver 118 for bidirectional wireless communications with the Node B 120, which also includes a data processor 122, a memory 124 that stores a program 126, and a suitable RF transceiver 128. The Node B 120 is coupled via a data path 130 to the RRM 140 that also includes a data processor 142 and a memory 144 storing an associated program 146. At least one of the programs 116, 126 and 146 is assumed to include program instructions that, when executed by the associated data processor, enable the electronic device to operate in accordance with the exemplary embodiments of this invention, as will be discussed below in greater detail.

In general, the various embodiments of the UE 110 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by the data processor 112 of the UE 110 and the other data processors, or by hardware, or by a combination of software and hardware.

The memories 114, 124 and 144 may be of any type suitable to the local technical environment and may be implemented using any suitable data storage technology, such as semiconductor-based memory devices, magnetic memory devices and systems, optical memory devices and systems, fixed memory and removable memory. The data processors 112, 122 and 142 may be of any type suitable to the local technical environment, and may include one or more of general purpose computers, special purpose computers, microprocessors, digital signal processors (DSPs) and processors based on a multi-core processor architecture, as non-limiting examples.

In accordance with exemplary embodiments of this invention, by making the allocated modulation scheme a function of the power allocated for each sub-band, the detection by the UE 110 of the applicable modulation scheme becomes relatively simple and straight-forward.

The exemplary embodiments of this invention use a plurality of modulation schemes over the system bandwidth for a message transmitted to a single UE 110 over multiple sub-bands that use a power sequence for interference reduction.

In accordance with the exemplary embodiments of this invention there is provided a maximum gap of one modulation order:
(QPSK - - - 16-QAM, or 16-QAM - - - 64-QAM)
for each transmission.

In one exemplary and non-limiting embodiment the power sequences applied by the Node B 120 in the frequency domain are standardized. At a minimum, the bands on which power sequences are used are known to the UEs 110. In this situation one of the following three cases is assumed to exist, either: a) power sequences with sufficient power differences are always used in all cells, b) it is signaled to the UE 110 that power sequences with sufficient power difference are used in a particular cell, c) or the UE 110 detects whether a power sequence with at least a threshold amount of power difference is in use (note that if one assumes that the UE 110 has knowledge of the bundled frequency resources, the detection can be performed with some reliability). For this purpose it is preferred that a standardized step in the power sequences exist, for example, differences smaller than about 3 dB would not be permitted by the applicable specification(s).

If one of the three cases (a), (b) or (c) is realized, it follows that if the AMC level is signaled to be QPSK, then the UE 110 can assume that QPSK is used on the low power regime, and 16-QAM on the high power regime (or vice versa, if the AMC is signaled to be 16-QAM, then QPSK is used on the low power regime), with a similar reduction in the AMC signaling.

This technique reduces signaling overhead due to bit loading in the frequency domain, and enhances gain.

It can be noted that it is desirable that there be some common knowledge between the UE 110 and the Node B 120 in order to reduce the amount of signaling between these two units.

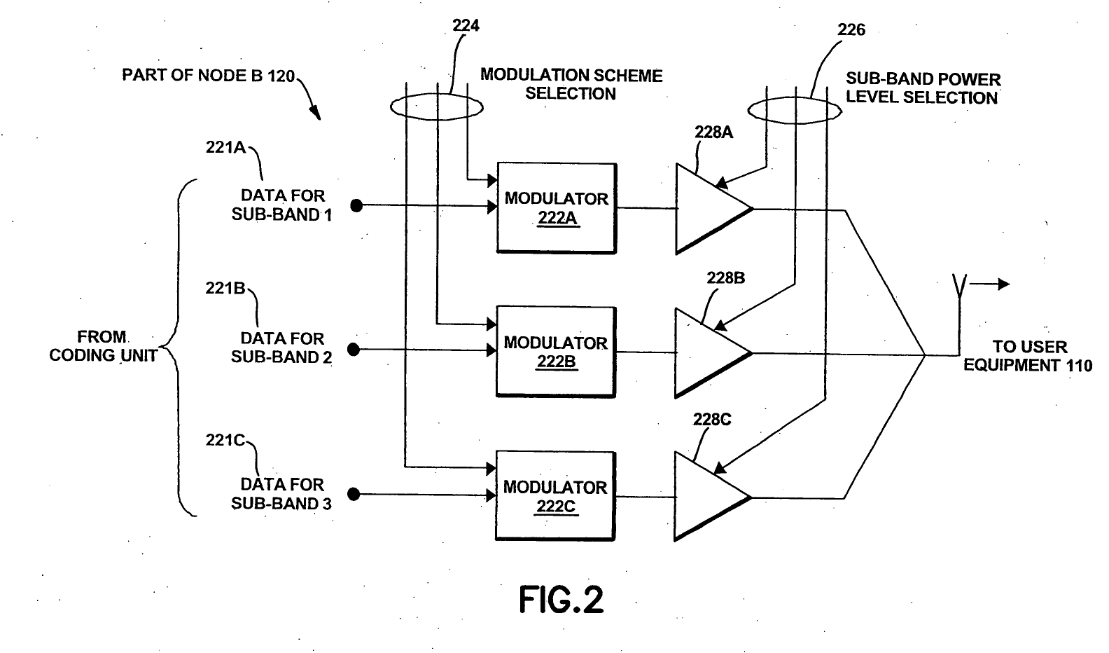

FIG. 2 is a conceptual block diagram of a portion of the Node B 120, and illustrates the use of different modulation schemes applied by modulators (MOD) 222A, 222B, 222C in different sub-bands transmitted on the downlink to the UE 110, as a function of the power level of the sub-bands. It may assumed that the Modulation Scheme Selection and Sub-Band Power Level Selection control signals 224, 226 are sourced directly or indirectly by the DP 120, under control of the Program 126. Typically the data 221A, 221B and 221C for the different modulators 222A, 222B, 222C will be sourced from the same coding unit (e.g., from a turbo coder), although a plurality of coding units may present in some applications. After being suitably modulated by modulators 222A, 222B and 222C, signals 221A, 221B and 221C are amplified by amplifiers 228A, 228B and 228C in accordance with the sub-band power level selection signals 226.

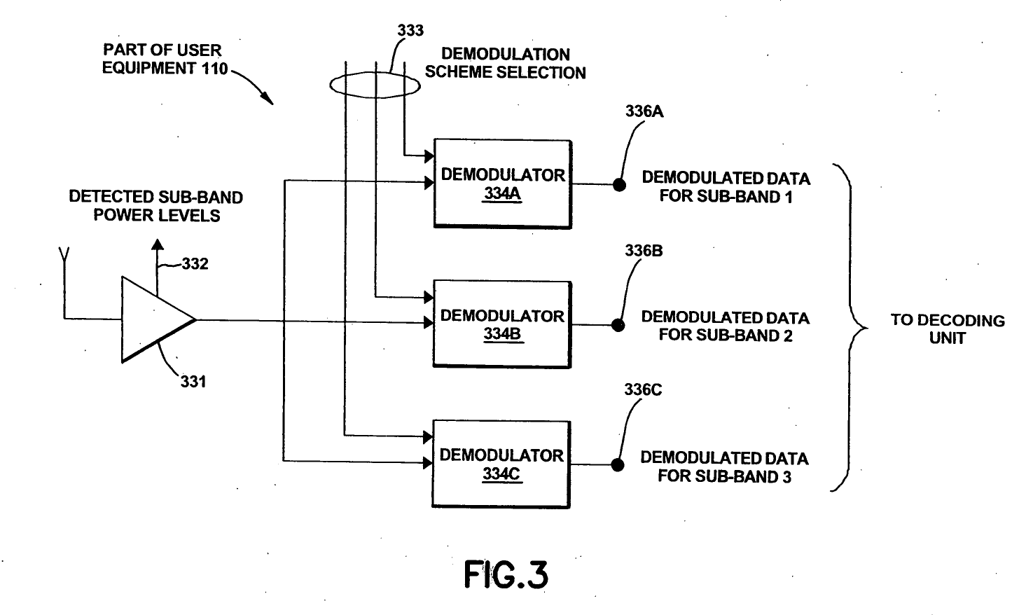

FIG. 3 is a conceptual block diagram of a portion of the UE 110, and illustrates the use of different demodulation schemes applied by demodulators (DEMOD) 334A, 334B, and 334C in demodulating signals from different sub-bands received on the downlink from Node B 120, as a function of the power level of the sub-bands. The sub-band power levels may be detected directly by the UE 110 (as shown), or may be known a priori by the UE 110, or signaled to the UE 110, as was discussed above. When detected, detector 331 generates a control signal 332 identifying the sub-bands by signal transmission power level. It may be assumed that the Demodulation Scheme Selection control signals 333 are sourced directly or indirectly by the DP 112, under control of the Program 1116, and that if used the sub-band power level indication signal would be input directly or indirectly to the DP 112 for use in generating the states of the Demodulation Scheme Selection control signals. Typically the data 336A, 336B, 336C from the different demodulators 334A, 334B, 334C will be output to the same decoding unit (e.g., to a turbo decoder), although a plurality of decoding units may present in some applications.

The advantages realized by the use of the exemplary embodiments of this invention are several. In one aspect the data rate is potentially increased by permitting the use of a higher order modulation on the high power sub-band (e.g., there can exist a 33% potential increase in peak throughput for the QPSK+16-QAM case), although in practice the actual increase may be less since the additional power may potentially also have been used to decrease the coding, thus also increasing the data rate. A more conservative estimate of the potential throughput increase is approximately 10%.

In another aspect, all of the bits for detection are provided with approximately the same average received SINR (excluding channel variations), thus leading to enhanced performance of the forward error correction scheme that is in use. With the described embodiments of this invention, these performance/throughput improvements can be achieved without increasing the AMC signaling overhead.

In a further non-limiting aspect of the invention, AMC is applied in the setting of a multi-antenna transmission. So called multiple-input multiple-output (MIMO) methods increase the data rate by adding the possibility to transmit multiple signal streams simultaneously to a user. Thus the AMC can be extended to operate, in addition to the modulation and coding domain, in the domain of the number of streams which all characterize a MIMO transmission method. In this aspect of the invention, there is a predefined connection between a MIMO transmission method applied on a low-power resource, and a MIMO transmission method applied on a high-power resource. Thus only one of these needs to be signaled. Note that the predefined connection may be limited to the part of the definition of a MIMO transmission scheme that relates to the data rate (i.e. code rate, modulation order, number of streams). In addition to these, data related to the channel realizations on the individual resource units, such as beam information, may or may not be used to determine a MIMO transmission.

Based on the foregoing it should be apparent that the exemplary embodiments of this invention provide a method, apparatus and computer program product(s) to selectively demodulate received signals as a function of the power level of various sub-bands in which the signals are received, where different modulation schemes are applied at a transmitter so as to substantially equalize at the receiver the received SINR of the signals in the various sub-bands.

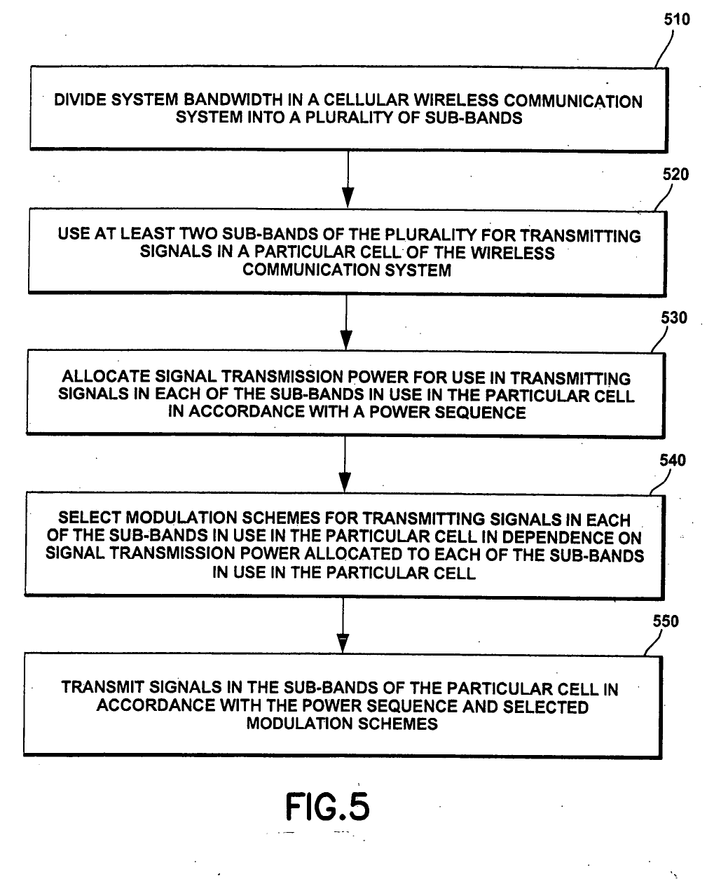

FIG. 5 is a flowchart depicting a method operating in accordance with the invention. At step 510, system bandwidth in a cellular wireless communications system is divided into a plurality of sub-bands. Then, at step 520, at least tow sub-bands of the plurality are used for transmitting signals in a particular cell of the cellular wireless communication system. Next, at step 530, signal transmission power for use in transmitting signals in each of the sub-bands in use in the particular cell is allocated in accordance with a power sequence. Then, at step 540, modulation schemes are selected for transmitting signals in each of the sub-bands in use in the particular cell in dependence on signal transmission power allocated to each of the sub-bands in use in the particular cell. Next, at step 550, signals are transmitted in the sub-bands in use in the particular cell in accordance with the power sequence and selected modulation schemes.

In a typical embodiment of the method depicted in FIG. 5, at one least sub-band in use in the particular cell of the cellular wireless communication system is allocated a higher signal transmission power level than the other cells. In another typical embodiment of the method depicted in FIG. 5, the system bandwidth is divided into at least three equal-sized sub-bands.

When performing step 530, signal transmission power is allocated in such a manner so as to mitigate signal interference with adjacent cells transmitting in at least some of the same sub-bands.

During typical operation of the method depicted in FIG. 5, system bandwidth is divided into at least first and second sub-bands. The first sub-band is allocated a higher signal transmission power level than the second sub-band. As described previously, when signals are transmitted in separate sub-bands at different power levels within a particular cell of the cellular wireless communications system, there may be differences in the SINR between the signals. Accordingly, when performing step 540 of selecting modulation schemes for transmitting signals in each of the sub-bands, the modulation schemes are selected in such a manner so as to reduce SINR differences between the first and second signals.

In variants of the method depicted in FIG. 5, additional steps may be performed in order to implement the method in user equipment and base stations operating within the cellular wireless communications system. In one such variant, an additional step of storing information in user equipment to be operated in the wireless communication system is performed to identify the modulation schemes selected for use in each of the sub-bands when signals are transmitted in the wireless communication system in accordance with the power sequence.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. For example, while the exemplary embodiments of the invention have been described above in the context of the UTRAN and E-UTRAN systems, it should be appreciated that the exemplary embodiments of this invention can be applied as well to other types of wireless communications systems, methods and schemes. Further by example, in other embodiments more or less than three sub-bands may be employed, as may different types of modulation schemes. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

1. A method comprising:
dividing system bandwidth in a wireless communication system into a plurality of sub-bands;
using at least two sub-bands of the plurality for transmitting signals in a particular cell of the wireless communication system;
allocating signal transmission power for use in transmitting signals in each of the sub-bands in use in the particular cell in accordance with a power sequence;
selecting modulation schemes for transmitting signals in each of the sub-bands in use in the particular cell in dependence on signal transmission power allocated to each of the sub-bands in use in the particular cell; and
transmitting signals in the sub-bands of the particular cell in accordance with the power sequence and selected modulation schemes.

2. The method of claim 1 wherein the power sequence allocates different signal transmission power levels to each of the sub-bands in use in the particular cell.

3. The method of claim 1 wherein the system bandwidth is divided into at least three equal-sized sub-bands.

4. The method of claim 1 wherein allocating signal transmission power to each of the sub-bands is done in such a manner so as to mitigate signal interference with adjacent cells transmitting in at least some of the same sub-bands

5. The method of claim 1 where the system bandwidth is divided into at least a first and a second sub-band, wherein as a result of allocating signal transmission power to each of the sub-bands in accordance with a power sequence, the first sub-band is allocated a higher signal transmission power level than the second sub-band.

6. The method of claim 5 wherein the modulation schemes are selected in such a manner so as to reduce a SINR difference between at least a first signal transmitted in the first sub-band and a second signal transmitted in the second sub-band, wherein the SINR difference arises from the fact that the first signal is transmitted at a higher transmission power level than the second signal.

7. The method of claim 1 wherein selecting modulation schemes to be used for transmitting signals in each of the sub-bands is done in such a way so as to reduce the SINR between signals transmitted in different sub-bands.

8. The method of claim 1 wherein the difference between a highest signal transmission power level allocated to a sub-band in the particular cell and the second-highest signal transmission power level is at least 4 dB.

9. The method of claim 1 further comprising:
storing information in user equipment to be operated in the wireless communication system identifying the modulation schemes selected for use in each of the sub-bands when signals are transmitted in the wireless communication system in accordance with the power sequence.

10. The method of claim 9 where signals are always transmitted in the particular cell of the wireless communication system in accordance with a power sequence, and wherein the following operations are performed at user equipment operative in the particular cell:
receiving signals transmitted in each of the sub-bands in use in the particular cell; and
using the information stored in the user equipment to select demodulation schemes to be used in demodulating signals received in each of the sub-bands in use in the particular cell.

11. The method of claim 9 where signals are occasionally transmitted in the particular cell of the wireless communication system in accordance with a power sequence, and wherein the following operations are performed at a base station operative in the particular cell:
transmitting a signal indicating to user equipment operative in the particular cell when signals are being transmitted in the particular cell in accordance with a power sequence.

12. The method of claim 11 where the following operations are performed at user equipment operative in the particular cell:
receiving the signal indicating that signals are being transmitted in the particular cell in accordance with the power sequence; and
using the information stored in the user equipment to select demodulation schemes to be used in demodulating signals received in each of the sub-bands in use in the particular cell.

13. The method of claim 9 further comprising the following operations performed at user equipment operative in the particular cell:
receiving signals transmitted in each of the sub-bands;
detecting the difference in signal transmission power levels used in transmitting signals in each of the sub-bands in use in the particular cell; and
using the detected difference in signal transmission power levels and information stored in the user equipment identifying the modulation schemes selected for use in each of the sub-bands when signals are transmitted in the wireless communication system in accordance with the power sequence to determine which demodulation scheme should be used to demodulate signals transmitted in each of the sub-bands in use in the particular cell.

14. A user equipment comprising:
a memory storing a program configured to control the user equipment when executed;
a transceiver configured for bidirectional communication across a plurality of sub-bands in a cellular wireless communications system;
a data processor coupled to the memory and transceiver, the data processor configured to execute the program and to control the user equipment; and
wherein the transceiver is further configured to receive a plurality of signals transmitted in a plurality of sub-bands within a particular cell of the cellular wireless communications system, wherein each signal transmitted in a particular sub-band is both transmitted in accordance with a power sequence, wherein the power sequence assigns a signal transmission power level to at least one of the sub-bands that is different from the signal transmission power levels assigned to other sub-bands; and modulated using a modulation scheme selected in dependence on the signal transmission power level allocated to the sub-band.

15. The user equipment of claim 14 wherein the memory of the user equipment is further configured to store information identifying modulation schemes assigned to different sub-bands used in the particular cell of the cellular wireless communications system; and wherein the transceiver further comprises a plurality of demodulators configured to demodulate signals received in each of the sub-bands in use in the particular cell of the cellular wireless communication system using the information identifying the modulation schemes assigned to different sub-bands used in the particular cell of the cellular wireless communications system.

16. The user equipment of claim 15 wherein the user equipment is configured to determine when signals transmitted in different sub-bands in use in a particular cell of the cellular wireless communications system are always transmitted in accordance with a power sequence.

17. The user equipment of claim 15 wherein the transceiver is further configured to receive a signal transmitted by a base station identifying when signals are being transmitted in the particular cell of the cellular wireless communications system in accordance with a power sequence.

18. The user equipment of claim 15 wherein the transceiver is further configured to determine when signal transmission power levels used to transmit signals in each of the sub-bands in use in a particular cell of the cellular wireless communications system indicate that a power sequence is being used to transmit the signals and to use this determination in combination with the information identifying modulation schemes assigned to different sub-bands to de-modulate the signals.

19. A base station comprising:
a memory storing a program configured to control the base station when executed;
a transceiver configured for bidirectional communication across a plurality of sub-bands in a cellular wireless communications system;
a data processor coupled to the memory and transceiver, the data transceiver configured to execute the program and to control the base station; and
wherein the transceiver is further configured to transmit a plurality of signals in a plurality of sub-bands of a particular cell in a cellular wireless communications system, wherein each signal transmitted in a particular sub-band is both transmitted in accordance with a power sequence, where the power sequence assigns a signal transmission power level to at least one of the sub-bands that is different from the signal transmission power levels that are assigned to other sub-bands; and modulated using a modulation scheme selected in dependence on the signal transmission power level assigned to the particular sub-band.

20. The base station of claim 19 where the transceiver comprises a plurality of modulators configured to modulate signals to be transmitted in the plurality of sub-bands in accordance with the modulation schemes selected for the sub-bands.

21. The base station of claim 19 where the transceiver is further configured to transmit a signal identifying when signals in the particular cell of the cellular wireless communication system are being transmitted in accordance with a power sequence.

22. A computer program product comprising a computer readable memory medium tangibly embodying a computer readable program, the computer readable program executable by data processing apparatus, the computer readable program, when executed, configured to divide system bandwidth in a wireless communication system into a plurality of sub-bands; to use at least two sub-bands of the plurality for transmitting signals in a particular cell of the wireless communication system; to allocate signal transmission power for use in transmitting signals in each of the sub-bands in use in the particular cell in accordance with a power sequence; to select modulation schemes for transmitting signals in each of the sub-bands in use in the particular cell in dependence on signal transmission power allocated to each of the sub-bands in use in the particular cell; and to transmit signals in the sub-bands of the particular cell in accordance with the power sequence and selected modulation schemes.

23. A computer program product comprising a computer readable memory medium tangibly embodying a computer readable program, the computer readable program executable by data processing apparatus, the computer readable program, when executed, configured to receive a signal indicating signal transmission power levels used in transmitting at least first and second signals in at least first and second sub-bands in a particular cell of a cellular wireless communications system; to determine the modulation schemes used to modulate the first and second signals in dependence on the signal indicating the signal transmission power levels used to transmit the first and second signals; and to demodulate the signals in accordance with the determined modulation schemes.

24. The computer program product of claim 23 wherein the computer readable program is further configured to control operations measuring the signal transmission power levels used in transmitting the at least first and second signals in at least the first and second sub-bands.

25. The computer program product of claim 23 wherein to determine the modulation schemes used to modulate the first and second signals the computer readable program is further configured to retrieve information associating modulation schemes with signal transmission power levels.

26. The computer program product of claim 23 wherein to determine the modulation schemes used to modulate the first and second signals the computer readable program is further configured to retrieve information associating modulation schemes with the first and second sub-bands.
